(19) United States
(12) Patent Application Publication
(10) Pub. No.: US 2019/0332384 A1
(43) Pub. Date: Oct. 31, 2019

(54) PROCESSOR ARCHITECTURE WITH SPECULATIVE BITS TO PREVENT CACHE VULNERABILITY

(71) Applicant: HEWLETT PACKARD ENTERPRISE DEVELOPMENT LP, Houston, TX (US)

(72) Inventors: Michael Bozich Calhoun, Roseville, CA (US); Divakar Chitturi, Roseville, CA (US); Scott Lee, Carmichael, CA (US)

(21) Appl. No.: 15/967,548

(22) Filed: Apr. 30, 2018

(51) Int. Cl. G06F 9/38

(52) U.S. Cl. CPC G06F 9/3842; G06F 9/3814

(57) ABSTRACT

A device including a logic unit configured to execute multiple instructions, and a schedule buffer that lists the instructions to be executed by the logic unit is provided. The device includes a fetch engine to retrieve data from an external memory, a cache including lines to hold the data associated with one of the instructions, including a spec-bit. The device includes a management unit to set the spec-bit to a speculative state when the data is retrieved for an instruction that has not been committed for execution by the logic unit, and to reset the spec-bit from a speculative state to a trusted state for a valid instruction. The management unit prevents the data from remaining in the cache when the spec-bit is in a speculative state. A computer system including the above device and a method of using the device are also provided.

### TECHNICAL FIELD

Embodiments described herein are generally related to the field of processor architectures for cache management. More specifically, embodiments described herein are related to hardware solutions to prevent vulnerabilities in the cache management of central processing units for computing devices.

### BACKGROUND

To take advantage of high processing capabilities of densely packed logic units in a logic unit such as a central processing unit (CPU), a graphic processing unit (GPU) and any other processor used in a computing device, current processor architectures are designed to perform out-of-order execution of multiple computational threads or branches. However, it has been recently demonstrated that cache management in current processor architectures may lead to serious vulnerabilities and data breaches from malicious third party applications running in parallel in the processor. The vulnerabilities arise from data being accessed from the cache, and which were brought into the cache by speculative instructions. The execution logic that determines if the instruction is valid does not complete before the memory is fetched into the cache. Current solutions to such vulnerability for data exposure include cache randomization techniques handled by software operating directly over the processor control. Software solutions operating on the old insecure hardware solution, like cache randomization, are almost certainly not more secure than a hardware solution like this. These software solutions, include a high cost in processing performance due to suppression of out of order logic, cache flushing, and modifications to memory management unit (MMU) and a translation lookaside buffer (TLB) behavior.

The description provided in the background section should not be assumed to be prior art merely because it is mentioned in or associated with the background section. The background section may include information that describes one or more aspects of the subject technology.

### SUMMARY

In certain aspects, a device as disclosed herein includes a logic unit configured to execute multiple instructions, and a schedule buffer that lists the instructions to be executed by the logic unit. The device also includes a fetch engine to retrieve data associated with the instructions from an external memory, a cache comprising multiple lines, wherein each line holds the data associated with one of the instructions, and wherein each line in the cache includes a spec-bit, and a management unit. The management unit is configured to set the spec-bit to a speculative state when the data is retrieved for an instruction that has not been committed for execution by the logic unit, and to reset the spec-bit from a speculative state to a trusted state when a valid instruction accesses the data associated with the spec-bit. The management unit is also configured to prevent the data associated with the spec-bit from remaining in the cache when the spec-bit is in a speculative state, and an execution of an instruction that fetched the data is determined to be invalid.

In certain aspects, a system as disclosed herein includes a memory storing multiple data and multiple instructions, and a processor configured to execute the instructions which use the data. The processor includes a schedule buffer that lists the instructions to be executed by the processor, and a fetch engine to retrieve data associated with the instructions from an external memory. The processor also includes a cache comprising multiple lines, wherein each line holds the data associated with one of the instructions, and wherein each line in the cache includes a spec-bit and a management unit. The management unit is configured to set the spec-bit to a speculative state when the data is retrieved for an instruction that has not been committed for execution by the processor, and to reset the spec-bit from a speculative state to a trusted state when a valid instruction accesses the data associated with the spec-bit. The management unit is also configured to prevent the data associated with the spec-bit from remaining in the cache when the spec-bit is in a speculative state, and an execution of an instruction that fetched the data is determined to be invalid.

In certain aspects, a method includes retrieving, with a fetch engine, a data associated with an instruction to be executed by a logic unit, from an external memory and copying the data to a data line in a cache, wherein the data line includes a spec-bit. The method also includes setting, with a management unit, the spec-bit to a speculative state when the instruction has not been committed for execution by the logic unit, resetting the spec-bit from a speculative state to a trusted state when a valid instruction accesses the data associated with the spec-bit, and preventing the data associated with the spec-bit from remaining in the cache when the spec-bit is in a speculative state and the instruction is a discarded speculative instruction.

In certain aspects, a system is described including a means for storing instructions. The system further includes a means to execute the instructions to perform a method, the method including retrieving, with the means to execute the instructions, a data associated with an instruction to be executed by a logic unit, from an external memory and copying the data to a data line in a cache, wherein the data line includes a spec-bit. The method also includes setting, with a management unit, the spec-bit to a speculative state when the instruction has not been committed for execution by the logic unit, resetting the spec-bit from a speculative state to a trusted state when a valid instruction accesses the data associated with the spec-bit, and preventing the data associated with the spec-bit from remaining in the cache when the spec-bit is in a speculative state and when the execution logic determines that the speculative execution path is incorrect and the in-progress results and temporary state of speculative execution are removed from the system.

### BRIEF DESCRIPTION OF THE DRAWINGS

FIG. 1 illustrates a computing device including a logic unit and a memory, according to some embodiments.

FIGS. 2A-D illustrate a logic unit configured to track cache lines fetched by speculative instructions, according to some embodiments.

FIG. 3 illustrates an architecture of a cache in a logic unit configured to prevent the data from remaining in the cache when it should not be there, according to some embodiments.

FIG. 4 is a flow chart illustrating steps in a method to handle instructions with a logic unit configured to resist speculative cache attacks, according to some embodiments.

FIG. 5 is a block diagram illustrating an example computer system, including a logic unit configured to reduce cache miss vulnerability, according to some embodiments.

In the figures, elements and steps denoted by the same or similar reference numerals are associated with the same or similar elements and steps, unless indicated otherwise.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not as restrictive.

### General Overview

The disclosed system provides a solution for high performance processing with substantial reduction of vulnerability to cache attacks from malicious third party applications by including an augmented cache coordinated with out-of-order execution instructions in the execution pipeline of a logic unit (e.g., a CPU, a GPU and the like). More specifically, embodiments as disclosed herein may be used for preventing processor vulnerabilities (e.g., “Meltdown” and “Spectre,” among other attacks that exploit speculative execution and the processor cache). The Meltdown and Spectre processor vulnerabilities exploit cache states that are modified by speculative execution to breach processor security. Typically, speculative instructions begin execution before they are known to be in the valid architectural instruction stream. When determined to be invalid due to a different code path being taken, the effect of speculative instructions are discarded before they change the processor state, however, their impact to the processor cache remains. Accordingly, exploitive code like Meltdown or Spectre cause speculative use of protected data to modify which lines are in the cache. Protected data may then be extracted by examining which cache lines are resident.

Software workarounds have been proposed, but they come at a cost of processor performance. Processor microcode (for processors that use microcode) may be modified to at least lower the exposure to speculative execution hazards, but at a cost of processor performance. A processor may link execution of the component micro-ops that make up complex instructions to avoid executing security functions ahead of data access. This would avoid the Meltdown vulnerability, but not the Spectre vulnerability. A processor may block speculative execution of data accesses that miss in the cache until they are known to not be speculative. This gives up some, but not all, of the performance benefit of speculative execution. Some approaches may avoid the current form of cache vulnerabilities, but requires more bandwidth to the cache to update the cache lines to non-speculative, and may expose a new hazard that keys on cache lines that were in the cache, but are displaced when a cache line is moved in and marked speculative, even if it is eventually invalidated because it is speculative.

Embodiments as disclosed herein provide a mechanism to prevent, at least partially, speculative instructions from leaving data in the processor cache if those instructions are found to be invalid (e.g., were executed speculatively out of order and later determined to be in the wrong path, for example, due to branch miss-prediction). Some embodiments enable speculative instructions to modify a cache state when the speculative instructions become architectural. In such configuration, using the cache provides a performance benefit from out of order execution.

The disclosed system addresses a technical problem tied to computer technology and arising in the realm of computer operation, namely the technical problem of cache attack vulnerabilities from speculative execution pathways. Further, embodiments as disclosed herein provide a substantial reduction of cache attack vulnerabilities at substantially no cost in processor performance, with reduced impact in hardware re-design of the logic unit (e.g., a CPU, a GPU, and the like), and real estate usage (e.g., modifying cache state or fetching data into cache).

Many attacks based on cache vulnerabilities of common processor architectures (e.g., Spectre and Meltdown) rely on cache tools that probe the state of the cache to recover secret information leaked by the speculative execution. To further prevent this information from leaking, for example during a probe command than runs before the management unit can evict the offending speculation, embodiments as disclosed herein prevent the cache probe tools and instructions from acting on cache lines with spec-bits set to a speculative state. In some embodiments, evicting a cache line includes removing a cache line when all lines are full and space is desired. When a cache line is evicted, some embodiments verify whether the evicted cache line contains modified data (e.g., ‘dirty’ data), When this is the case, some embodiments ensure that dirty data is written back to memory. In some embodiments, queries to cache lines marked with a speculative state will return the same information as if those cache lines were invalid. Thus, after a period of time most, or all, speculative cache lines issued after a given boundary may be cleared from the cache (evicted, retired, or validated). In some embodiments, architectural instructions that enforce serialization, atomicity, and boundaries, like ‘fence,’ ‘sfence,’ ‘lfence,’ ‘wall,’ and the like, are used to prevent speculative execution/fetch/probe of speculative cache lines. Embodiments as disclosed herein reduce the performance impact of invalidating speculative cache lines, compared to non-targeted approaches that invalidate the entire cache (e.g., by enforcing memory barriers), or rewriting the operating system kernel to prevent the shared memory from leaking secret or encrypted information. Speculative cache lines that are invalidated avoid “write-back to memory” steps. Lines fetched into the cache that are never used cause cache pollution, contending for the same resources as valid data and evicting useful data due to capacity. Invalidating cache lines fetched by speculative instructions that are not in the valid instruction stream improves cache performance.

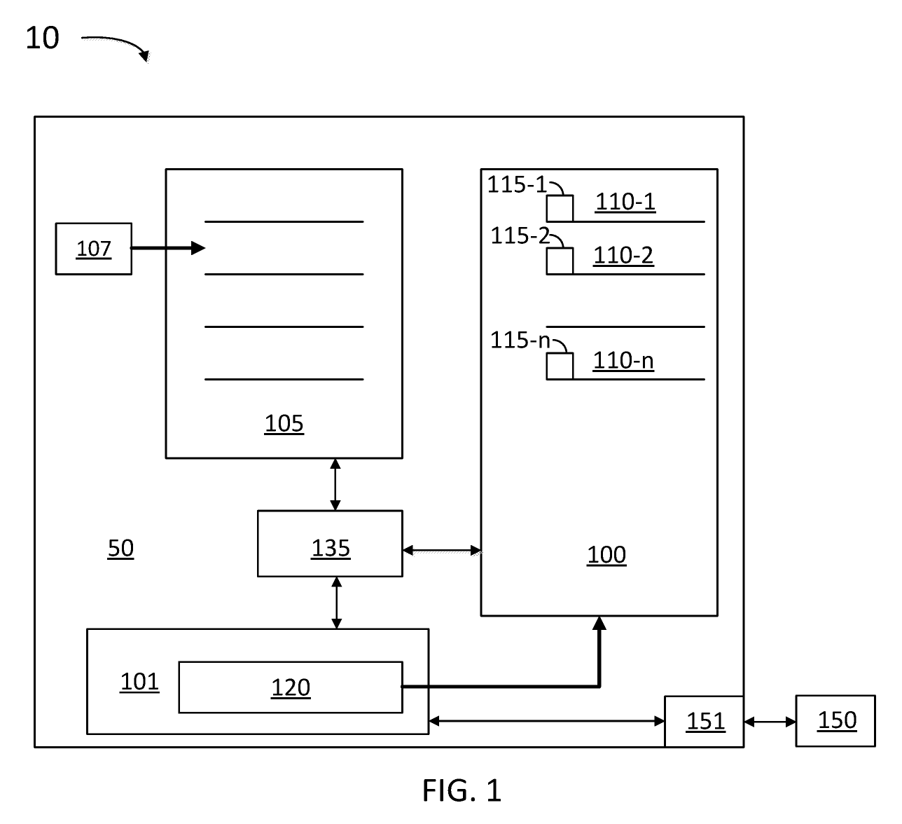

FIG. 1 illustrates a computer device 10 including a logic unit 50 and a memory 150, according to some embodiments. Logic unit 50 is configured to execute multiple instructions (e.g., a CPU, GPU and the like, or any processor used in a computing device) listed in a schedule buffer 105. Schedule buffer 105 may include a branch predictor unit (BPU) 107 that determines the next instruction in line for execution in schedule buffer 105. BPU 107 includes a logic circuit to detect an invalid branch of instructions when a first instruction in a separate branch is committed for execution. Logic unit 50 also includes a fetch engine 101 to retrieve data associated with the instructions from an external memory 150. Fetch engine 101 includes a cache probe 120.

Cache probe instructions (e.g., from cache probe 120) exist outside of the architectural defined state of cache 100. Speculative instructions modify cache 100 and then the cache probe instructions read micro-architectural state from cache 100. In some embodiments, the instructions to be executed by logic unit 50 in schedule buffer 105 have been checked for dependency prior to be listed in schedule buffer 105. In some embodiments, logic unit 50 further includes an out-of-order logic which, together with cache 100 and schedule buffer 105, exists outside the architectural defined state of the system (or processor). In some embodiments, schedule buffer 105 is configured to invalidate a speculative instruction that has not been executed prior to a current instruction that is being executed.

Logic unit 50 also includes a cache 100 having multiple cache lines 110-1, 110-2 through 110-n (hereinafter, collectively referred to as “cache lines 110”). Each cache line 110 holds data associated with one of the instructions in schedule buffer 105. Furthermore, each line in the cache comprises a spec-bit 115-1, 115-2 through 115-n (hereinafter, collectively referred to as “spec-bits 115”). Spec-bits 115, together with cache and schedule buffer, are key pieces to improve performance and robustness of the microarchitecture. A cache management unit 135 is configured to set the spec-bit to a speculative state when the data is retrieved for a transient instruction, where a transient instruction is executed out of order and not yet known to be in an architectural instruction stream. In some embodiments, cache management unit 135 is also configured to reset the spec-bit from a speculative state to a trusted state when a valid instruction accesses the data associated with the spec-bit, and to prevent the data associated with the spec-bit from remaining in the cache when the spec-bit is in a speculative state and a squash occurs. In a squash event, the execution logic determines that the speculative execution path is incorrect and the in-progress results and temporary state of speculative execution is removed from the system. Accordingly, in some embodiments a squash event includes removing speculative lines from the cache when speculative execution is found to be invalid.

Memory 150 may include a volatile memory, e.g., dynamic, random-access memory (DRAM), and the like (e.g., disposed in a dual in-line memory module—DIMM). Further, in some embodiments, memory 150 may include nonvolatile memory as well (e.g., a magnetic disk, a hard drive, and the like). A memory interface 151 may be part of logic unit 50 and configured to establish communication with, fetch data from, and write data into, memory 150. When there is a cache “miss” (e.g., an instruction in schedule buffer 105 calls for data that is missing in cache 100), cache management unit 135 instructs memory interface 151 to fetch the missing data from memory 150. The further away the missing data is located in memory 150, the longer it takes to recover and the more likely it is for the data miss to be detected by a third party, and the retrieved data to be revealed.

Instructions in schedule buffer 105 may include memory access instructions, i.e., an instruction that reads or writes data to memory 150, or to cache 100 (e.g., “load/store” instructions). In some embodiments, schedule buffer 105 may also include arithmetic instructions anteceding or succeeding load/store instructions. Schedule buffer 105 may include an execution pipeline with 28 instructions, 64 instructions, or many more (e.g., 1000 or 2000).

Instructions in schedule buffer 105 may be speculative or non-speculative, according to the level of certitude that the instruction will be executed by logic unit 50. For example, a given instruction listed further down in schedule buffer 105 may generally start out as a speculative instruction. Execution of speculative instructions may be desirable to improve the processor performance, especially during parallel computation, when there are pieces of a complex sequence of operations that may be performed out of sequence. Some speculative instructions in schedule buffer 105 may be discarded when preceding instructions are executed. When the speculative instruction is not discarded before it moves up the list in schedule buffer 105, it transitions into a non-speculative instruction (e.g., the next instruction to be executed by logic unit 50 is non-speculative). In some embodiments, a speculative instruction becomes non-speculative at the point of retirement (or scheduling for retirement). In some embodiments, an instruction may start out as non-speculative in schedule buffer 105 when it belongs to a branch or thread that will certainly be executed by logic unit 50, regardless of how far along the pipeline is in schedule buffer 105.

In some embodiments, cache management unit 135, together with BPU 107, handle exceptions and micro architectural states to detect execution of speculative instructions. Cache management unit 135 then evicts speculative instructions from schedule buffer 105 before they impact the architectural state when they turn out to not be in the path of the retired instruction stream (incorrect branch prediction, exception, L2 cache miss, and the like). Instructions that began execution, but are not supposed to affect the architectural state, often still have measureable results because they may modify cache 100. When an event in the microarchitecture results in transient instructions being evicted from schedule buffer 105 and schedule buffer 105 is emptied and a correct path is filled in, cache 100 removes (marks as invalid) speculatively fetched cache lines. Thus, in some embodiments, logic unit 50 avoids a “cache miss” event, without the need to call memory interface 151 to retrieve the missing data from memory 150. Accordingly, whether an instruction requesting the data is speculative or in the valid instruction stream, the requested data is fetched by cache management unit 135 from either cache 100, whichever “hits” the access request. Accordingly, cache management unit 135 may be configured to modify the spec-bit 115 of cache 100 to move in missing data that is not already present (e.g., from memory 150), or to evict data to free space in cache 100.

Cache management unit 135 removes cache lines 110 from cache 100 with schedule buffer 105. Schedule buffer 105 sets the speculative bit from the cache when the execution logic detects that the incorrect instruction stream is being executed, or detects that speculative execution needs to be thrown away/squashed/reverted when spec-bit 115 is in a speculative state for an invalid instruction. Cache management unit 135 prevents cache probe instructions (e.g., from probe 120) to interact with data in a cache line associated with a spec-bit in a speculative state. In some embodiments, cache management unit 135 is further configured to prevent an external source to access data in a cache line 110 associated with a spec-bit 115 in a speculative state. The external source may include at least one of a ‘read line’ presence, a ‘cache flush’ request, and a ‘read’ from a second logic unit.

In some embodiments, cache management unit 135 prevents timing-based attacks where speculative data lines in the cache are timed to provoke a cache hit/miss. Cache management unit 135 may also prevent page-location based attacks in which a cached page location reveals secret data (leaked by speculative execution) from the unprivileged memory space. Cache management unit 135 also prevents Spectre attacks that use branch prediction training to execute speculative code snippets (‘gadgets’) by re-setting the spec-bit 115 of cache line 110 after the branch predictor is resolved. For example, a Spectre attack uses branch predictors to miss-predict a branch and execute invalid speculative code. Such attack is averted by embodiments disclosed herein that prevent the issue of such speculative instructions by removing the cache lines having the spec-bit when the branch miss-prediction that was exploited by the attack is detected.

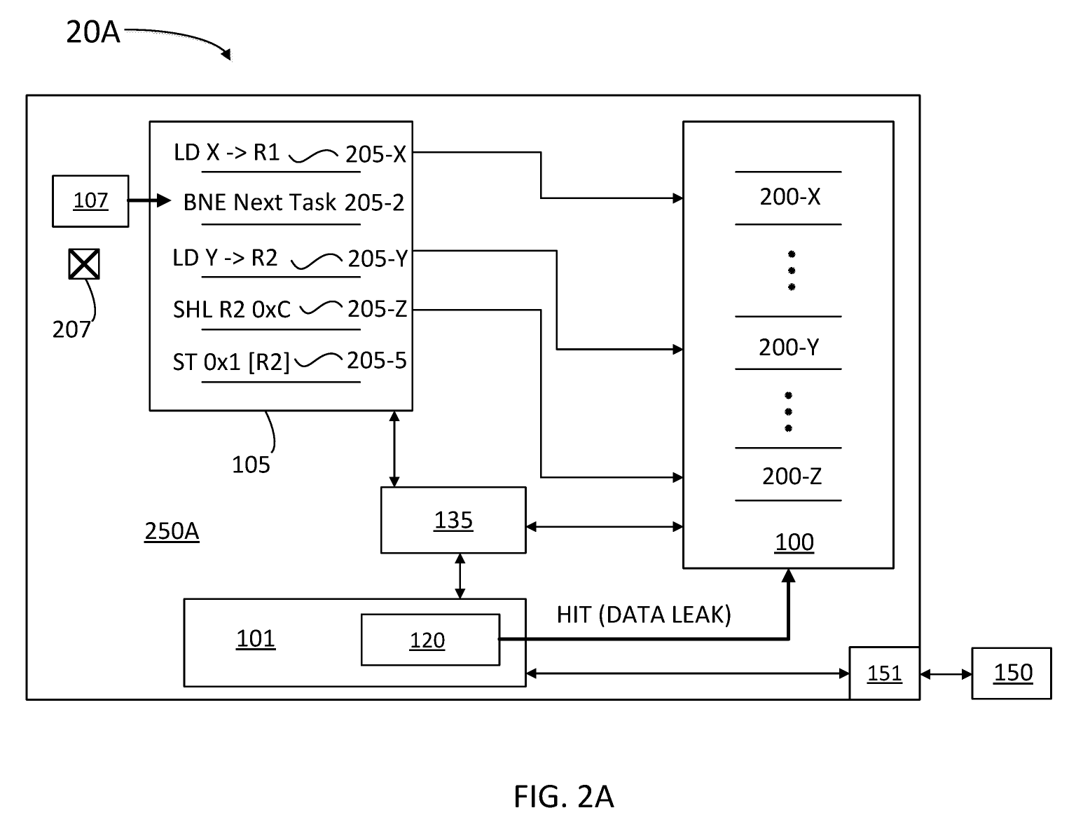

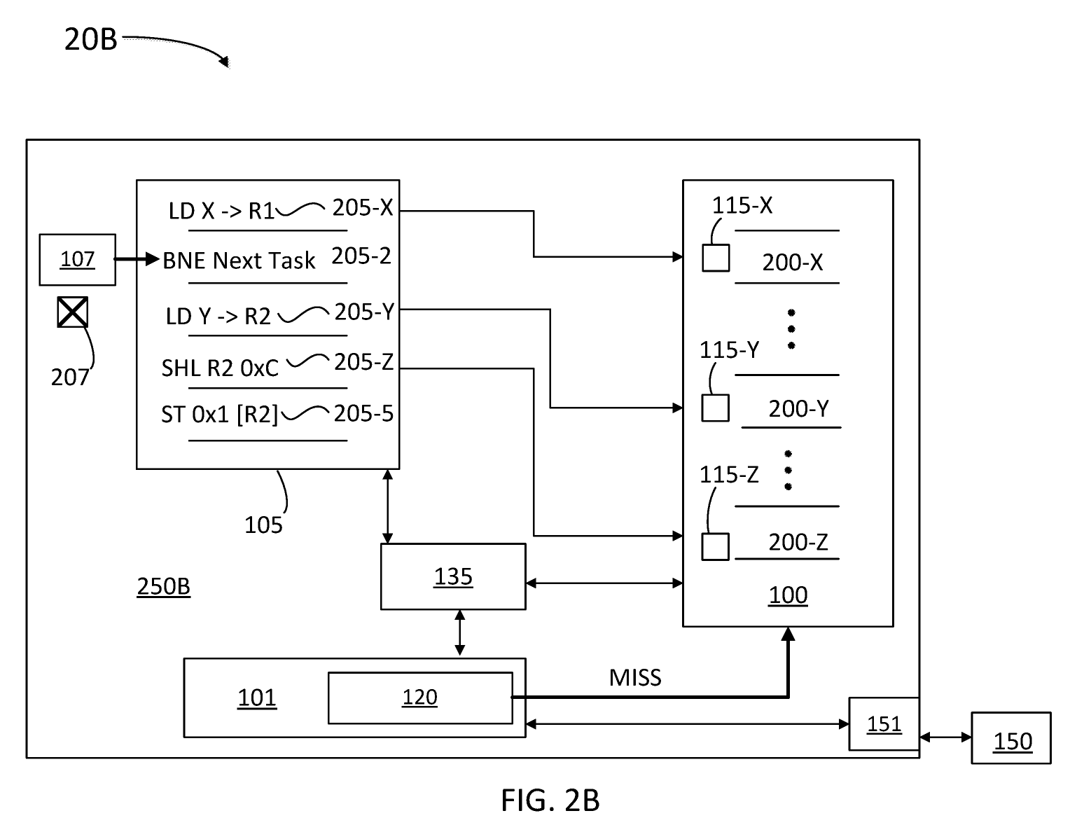

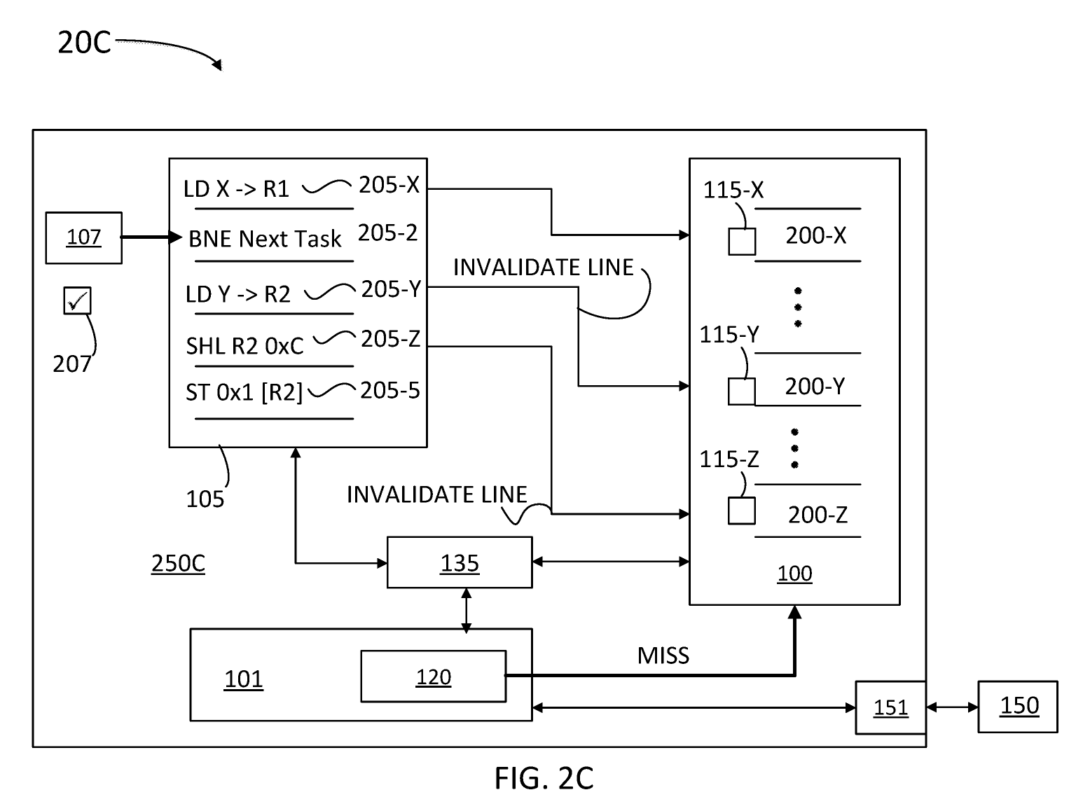

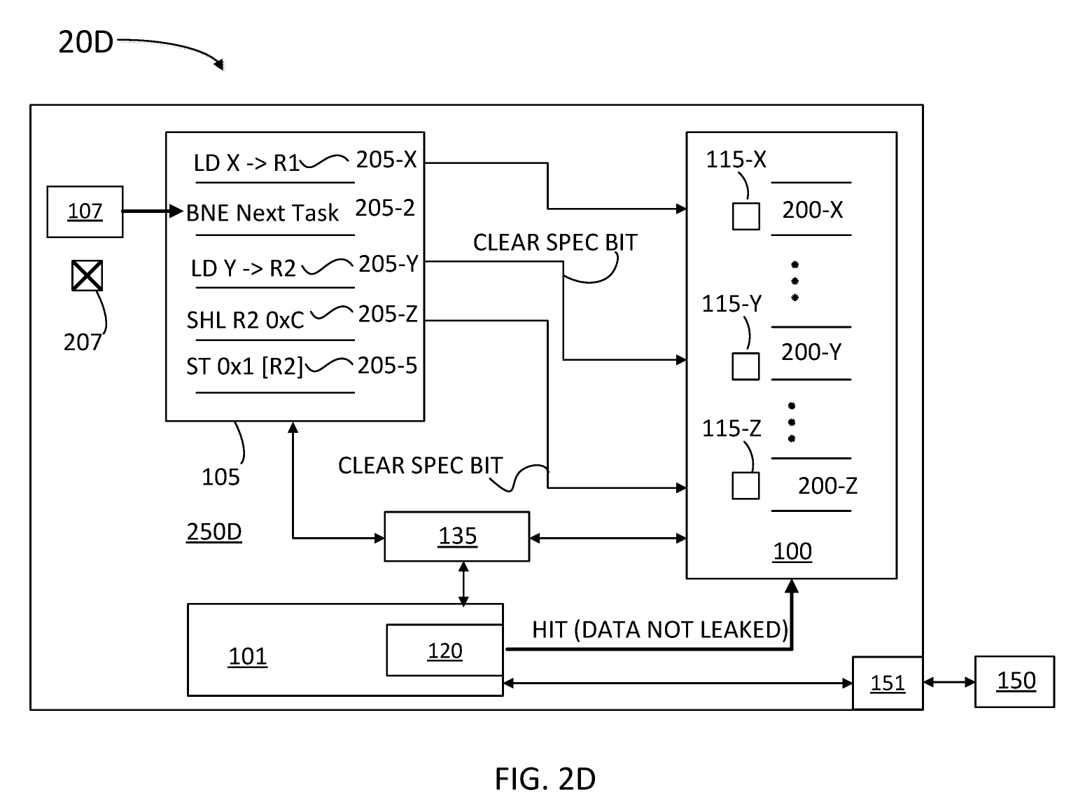

FIGS. 2A-D illustrate computer devices 20A, 20B, 20C, and 20D (hereinafter, collectively referred to as “computer devices 20”) respectively, configured to track cache lines fetched by speculative instructions, according to some embodiments. Computer devices 20 include logic units 250A, 250B, 250C, and 250D (hereinafter, collectively referred to as “logic units 250”), respectively. As illustrated above (cf. computer device 10 and logic unit 50), computer devices 20 include a memory 150, a memory interface 151, a schedule buffer 105, a cache 100, a cache management unit 135, a probe 120, a BPU 107, and a fetch engine 101.

Schedule buffer 105 holds instructions 205-X, 205-2, 205-Y, 205-Z, and 205-5 (hereinafter, collectively referred to as “instructions 205”). Instructions 205 are decoded and issued by the front end of computer devices 20. In some instances, and depending on BPU 107, some of instructions 205 may be identified as non-speculative (e.g., current PC instructions), and some of instructions 205 may be identified as speculatively issued instructions. When an instruction 205 is determined to be speculative, it is slated for eviction from schedule buffer 105 because it is a transient instruction and it is desirable that it does not change the architectural state of logic units 250 (e.g., the cache lines in cache 100). At a later time, probe 120 determines when a memory address is ‘cached’ (e.g., when a cache line including data revealing an address location in memory 150 is accessed). Cache 100 includes cache line 200-X (fetched by instruction 205-X), cache line 200-Y (fetched by instruction 205-Y) and cache line 200-Z (fetched by instruction 205-Z). When instruction 205-X is an instruction that will be retired at a later point (e.g., executed by logic units 250), then cache line 200-X is a valid data entry and it is desirably maintained in cache 100. When instruction 205-X is a speculative instruction (e.g., one that may be evicted from schedule buffer 105), then cache line 200-X may expose a vulnerable address location in memory 150 if it is accessed by a malicious agent controlling cache management unit 135 (e.g., a third party application running on logic units 250).

FIG. 2A shows computer device 20A under a possible meltdown attack. The speculative execution logic fetches and issues a number of instructions 205-X, 205-2, 205-Y, 205-Z, and 205-5 after the memory access to cache line 200-1 (X), which is slow if not cached. The next instruction (e.g., instruction 205-2) is a branch that depends on the slow memory access to X, so it will access BPU 107. Spectre attacks train BPU 107 to force certain speculative branch paths, allowing selected instructions to run speculatively. In some scenarios, BPU 107 may predict that instructions 205-2 through 205-5 will be “Not Taken” (bit 207 in low state) so that follow-through instructions 205-3, 205-4 and 205-5 are speculatively executed. In a common Meltdown attack, the instruction stream tries to access a location in memory 150 for data in cache line 200-2 (Y). This location may include a secret value not accessible in memory 150. Accordingly, the speculative attack (e.g., Meltdown) attempts to access this memory location by computing the secret value (shift left L2==multiply by 4096) to generate an address Z and then finding the location of Z when probe 120 detects the incorrect path (e.g., speculative instructions 205-3, 205-4, and 205-5) and evicts instructions 205-3, 205-4 and 205-5. Having the value of location Z, the speculative attack then determines the secret value stored at Y. In some embodiments, cache probe instructions may return a result even for speculative instructions, however, the result may not be present in the cache when probing for a cache line that was not actually there or in the case that it was in fact present but had the spec bit set.

FIG. 2B shows the process of using spec-bits 115 to identify speculative and non-speculative cache lines. Accordingly, cache lines 200-X and 200-Y, associated with speculative instructions 205-1, 205-2 and 205-3 are marked with spec-bits 115-X and 115-Y, respectively. Spec-bits 115-X and 115-Y are identified as speculative (e.g., high bit value). Any attempt from probe 120 to access memory locations associated with cache lines 200-X and 200-Y while instructions 205-X and 205-Y are still in speculative state result in no data being returned from memory 150. Accordingly, whether probed before or after a squash, cache lines with speculative bit set cannot be seen by cache probe instructions and would see the same result of ‘not present’ both before (present, speculative) or after (when they have been invalidated).

FIG. 2C continues from FIG. 2B. After a first access to cache line 200-X has returned, the branch can resolve and it is “Taken,” (bit 207) meaning the later instructions 205-Y, 205-Z, and 205-5 which were executed speculatively are not valid and should be evicted. Cache management unit 135 invalidates cache lines 200-X, 200-Y and 200-Z before probe 120 finds the locations for cache lines 200-Y and 200-Z in memory 150.

FIG. 2D shows operation of the logic units 250 when speculative instructions 205-X, 205-Y and 205-Z are in a ‘true’ instruction stream (including access to locations Y and Z being permitted) and the branch is resolved as Not Taken (bit 207 to high). As schedule buffer 105 retires each instruction in order, it clears spec-bit 115 on cache lines that it consumes/writes. After all speculative instructions have resolved, there may be no spec-bits 115 set to high (speculative), remaining in the cache.

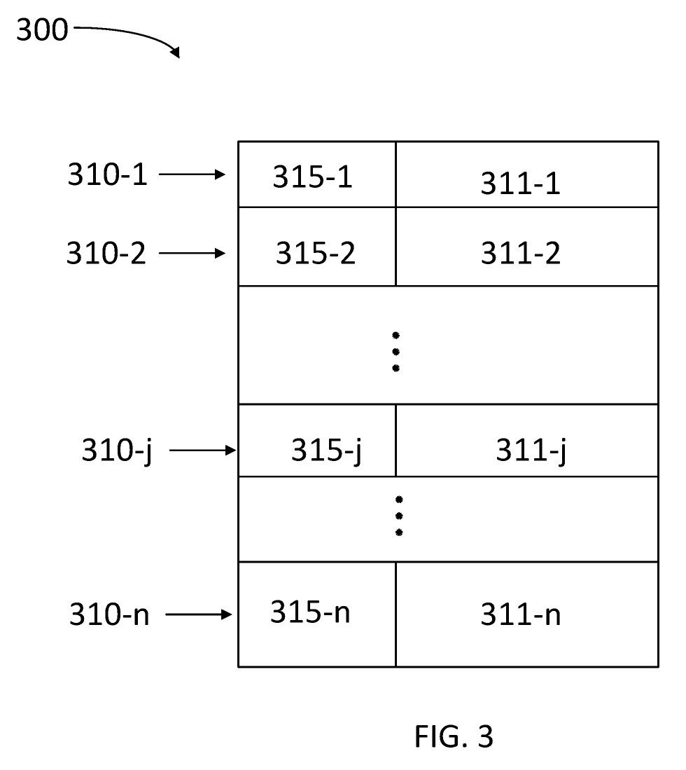

FIG. 3 illustrates an architecture of a cache 300 in a logic unit configured to be inert to speculative cache attacks (e.g., logic units 50 and 250), according to some embodiments. Cache 300 includes cache lines 310-1, 310-2, through 310-n (hereinafter, collectively referred to as “cache lines 310”). Each of cache lines 310 includes a spec-bit 315-1, 315-2, through 315-n (hereinafter, collectively referred to as “spec-bits 315”) and a data line 311-1, 311-2, through 311-n (hereinafter, collectively referred to as “data lines 311”). Spec-bits 315 may be a one-register set to a high state (‘1,’ or ‘speculative state’) when the corresponding data line 311 was fetched by a speculative instruction, and to a low state (‘0,’ or ‘true state’) when the corresponding data line 311 was fetched by a non-speculative instruction.

When spec-bit 315-j indicates a speculative state (1≤j≤n), modifications to cache line 311-j are prevented from altering the architectural state of cache 300. One example of speculative instructions may include micro-operations (μOPs, cf. Meltdown attacks) generated by the computer device. Spec-bit 315 keeps track of the speculative execution state of each μOP. Accordingly, many cache lines 310 may have a spec-bit 315 in a speculative state (e.g., when the logic unit speculatively executes a long series of instructions). The performance penalty from marking spec-bits 315 in cache 300 by the management unit is relatively low, compared to the common tasks of setting a parallel path to the logic unit and cache 300. In some embodiments, spec-bits 315 may include a few mega-bits (10⁶ bits, or ‘Mb’) and ROB entry (if needed), with the associated logic to access and handle the bits. The associated logic may include one, two, or more columns of complementary metal-oxide semiconductor (CMOS) gates, such as NAND and OR gates, using negative channel and positive channel field effect transistors (NFETs/PFETs). Accordingly, setting, evaluation, and tracking of spec-bit 315 has only a limited effect on critical path timing for the computations of the logic unit. In some embodiments, spec-bit 315 spec bits to be set to a speculative state in cache 300 when cache line 311 is fetched by a speculative instruction. In some embodiments, a number of cache lines 311 with spec-bit 315 set to a speculative state may be bounded due to a limitation in the number of in-flight speculative instructions.

When a non-speculative instruction accesses a cache line 310-j that has spec-bit 315-j set to speculative state (e.g., 315-j=‘1’), the management unit may reset spec-bit 315-j back to a true state (e.g., 315-j=‘0’). This process results in the re-setting of many spec-bits 315 from a speculative state to a true state set in cache 300. Accordingly, re-setting spec-bits 315 prevents cache 300 from being filled with speculative bits 315 when many speculative instructions are fetched/decoded/issued.

In some embodiments, a logic unit as disclosed herein may be implemented in the context of a ‘modified,’ ‘owned,’ ‘exclusive,’ ‘shared,’ and ‘invalid’ (MOESI) cache coherency protocol. In such configurations, for each cache state, the interaction when spec-bit 315 is in the speculative state (‘SB’) creates a matrix of spec-bit values in addition to the MOESI cache states. Accordingly, in embodiments consistent with the present disclosure, states that may expose a vulnerability to cache attacks are eliminated by design, and other states are converted to ‘invalidate the cache line’ without further concerns. Some of the states may include the following:

Modified and speculative (M+SB): This may be an empty state because, until the retire logic sees a memory ‘write’ in schedule buffer 105, the management unit will not modify the cache line. No other thread/core (e.g., a different instruction branch from the same or a different logic unit) can write cache line 310 without clearing SB to ‘0’ (true state).

Owned, speculative, and dirty (O+SB+Dirty): This may be an empty state because the logic unit may not write cache line 310-j (e.g., make it ‘dirty’) until spec-bit 315-j is in a true state. When cache line 310-j was already in an O+dirty state, most likely spec-bit 315-j would be in a true state.

Owned, speculative, and clean (O+SB+Clean): In this case, the management unit may invalidate cache line 310-j (Exclusive).

Exclusive and speculative (E+SB): The management unit may invalidate cache line 310-j (Shared).

Shared and speculative (S+SB): The management unit may invalidate cache line 310-j.

Invalid and speculative (I+SB): May be an empty state, because when cache line 310-j is invalid, the spec-bit 315-j may be cleared automatically (e.g., SB may not be set for Invalid lines).

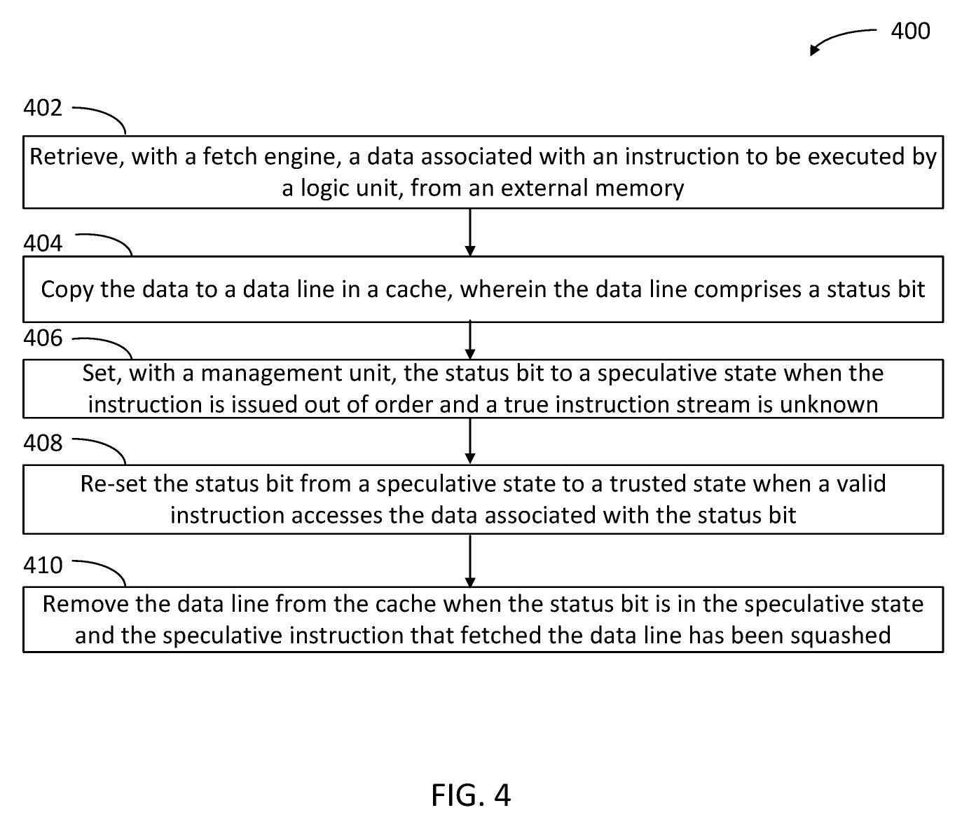

FIG. 4 illustrates a flow chart including steps in a method 400 for reducing speculative execution attacks using the cache in a central processing unit, according to some embodiments. At least one or more of the steps in method 400 may be performed by a central processing unit, including a processor, an instruction queue, a cache, an augmented cache, a cache management unit, and an instruction fetch engine, as disclosed herein (e.g., logic unit 50, schedule buffer 105, cache 100, cache management unit 135, and fetch engine 101. Methods consistent with the present disclosure may include at least one or more of the steps in method 400, performed in any order. For example, in some embodiments, a method may include one or more of the steps in method 400 performed overlapping in time, simultaneously, or quasi simultaneously.

Step 402 includes retrieving, with a fetch engine, a data associated with an instruction to be executed by a logic unit, from an external memory. In some embodiments, step 402 includes retrieving the data when the instruction is not known to be in the architectural instruction stream.

Step 404 includes copying the data to a data line in a cache, wherein the data line comprises a spec-bit.

Step 405 includes setting, with the management unit, the spec-bit to a speculative state when the instruction is issued out of order and a committed program order is unknown. In some embodiments, step 406 includes setting, with a management unit, the spec-bit to a speculative state when the instruction has not been committed for execution by the logic unit. In some embodiments, step 406 includes setting the spec-bit to a speculative state when the instruction that fetched the cache line is itself speculative. In some embodiments, step 406 is performed when the instruction is speculative, or when the instruction is not known to be in the architectural stream.

Step 408 includes re-setting the spec-bit from a speculative state to a trusted state when a valid instruction accesses the data associated with the spec-bit. In some embodiments, step 408 includes setting the spec-bit to a trusted state when the instruction is an architectural instructions, or when the schedule buffer reaches the head (e.g., the instruction is the next to be executed and becomes architectural).

Step 410 includes removing data in the cache that has the spec-bit in a speculative state when the speculative execution is squashed. In some embodiments, step 410 includes removing the data in the cache that was fetched by an instruction when the execution logic determines that the instruction belongs to an incorrect speculative instruction path that has been executed. In some embodiments, step 410 includes removing data from the cache when the data is associated with a spec-bit in a speculative state for an invalid instruction. In some embodiments, step 410 also includes preventing cache probe instructions to interact with data in a cache line associated with a spec-bit in a speculative state. In some embodiments, step 410 also includes preventing an external source to access data in a cache line associated with a spec-bit in a speculative state. The external source may include at least one of a read line presence, a cache flush request, and a read from a second processor. In some embodiments, step 410 includes invalidating a speculative instruction that has not been executed prior to a current instruction that is being executed. In some embodiments, step 410 includes defining, with an out-of-order logic, a micro-architecture state configured to be modified non-deterministically to improve a processor performance. The management unit is also configured to prevent the data associated with the spec-bit from remaining in the cache when the spec-bit is in a speculative state and a squash occurs. In some embodiments, step 410 includes removing cache lines from the cache when the spec-bit is in a speculative state and the speculative instruction that fetched the cache line is invalid.

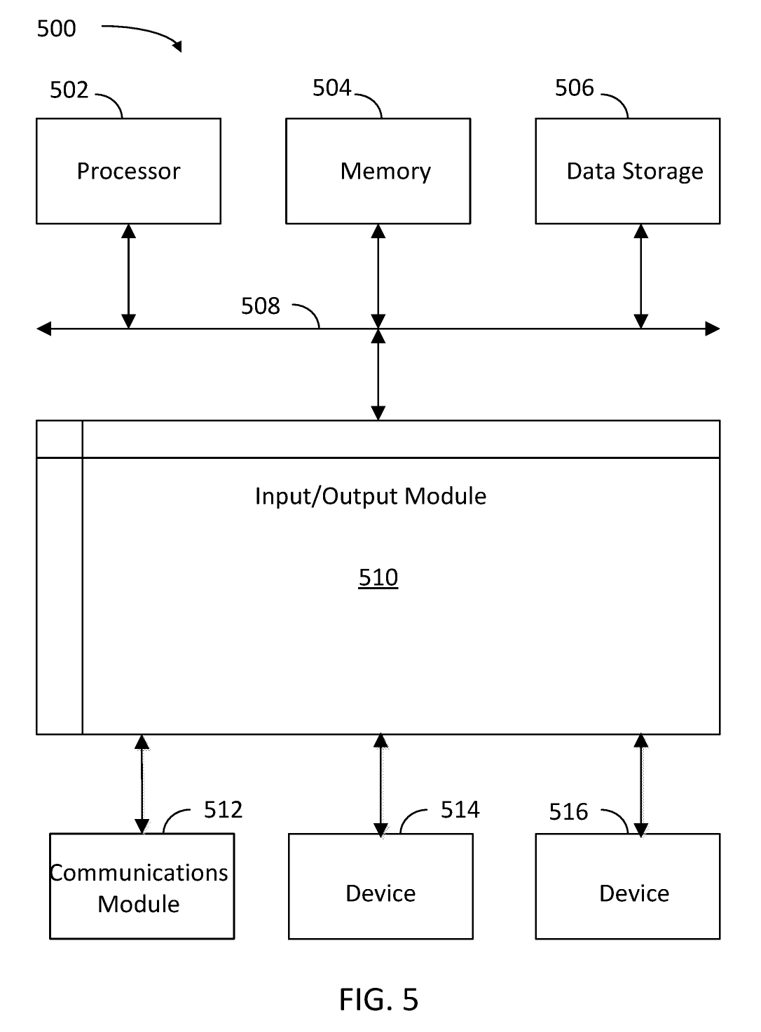

FIG. 5 is a block diagram illustrating an example computer system 500, including a logic unit configured to reduce speculative execution attacks that target the cache, according to some embodiments. In certain aspects, computer system 500 can be implemented using hardware or a combination of software and hardware, either in a dedicated server, integrated into another entity, or distributed across multiple entities. Moreover, in some embodiments, computer system 500 may be configured to perform at least some of the steps in method 400.

Computer system 500 includes a communication path 508 or other communication mechanisms for communicating information, and a processor 502 coupled with communication path 508 for processing information. By way of example, computer system 500 can be implemented with one or more processors 502. Processor 502 can be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. In some embodiments, processor 502 may include modules and circuits configured as a ‘placing’ tool or engine, or a ‘routing’ tool or engine, to place devices and route channels in a circuit layout, respectively and as disclosed herein.

Computer system 500 includes, in addition to hardware, code that creates an execution environment for the computer program in question, e.g., code that constitutes processor firmware, a protocol stack, a database management system, an operating system, or a combination of one or more of them stored in an included memory 504, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to communication path 508 for storing information and instructions to be executed by processor 502. Processor 502 and memory 504 can be supplemented by, or incorporated in, special purpose logic circuitry.

The instructions may be stored in memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to communication path 508 for storing information and instructions.

Computer system 500 is coupled via input/output module 510 to various devices. The input/output module 510 is any input/output module. Example input/output modules 510 include data ports such as USB ports. The input/output module 510 is configured to connect to a communications module 512. Example communications modules 512 include networking interface cards, such as Ethernet cards and modems. In certain aspects, the input/output module 510 is configured to connect to a plurality of devices, such as an input device 514 and/or an output device 516. Example input devices 514 include a keyboard and a pointing device, e.g., a mouse or a trackball, by which a user can provide input to the computer system 500. Other kinds of input devices 514 are used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as an LED (light emitting diode), CRT (cathode ray tube), or LCD (liquid crystal display) screen, for displaying information to the user.

Methods as disclosed herein may be performed by computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein (e.g., as in method 400). One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 includes servers and personal computer devices. A personal computing device and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise communication path 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

In one aspect, a term field effect transistor (FET) may refer to any of a variety of multi-terminal transistors generally operating on the principals of controlling an electric field to control the shape and hence the conductivity of a channel of one type of charge carrier in a semiconductor material, including, but not limited to, a metal oxide semiconductor field effect transistor (MOSFET), a junction FET (JFET), a metal semiconductor FET (MESFET), a high electron mobility transistor (HEMT), a modulation doped FET (MODFET), an insulated gate bipolar transistor (IGBT), a fast reverse epitaxial diode FET (FREDFET), and an ion-sensitive FET (ISFET).

To the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, and other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A processor, comprising:
a logic unit configured to execute multiple instructions;
a schedule buffer that lists the instructions to be executed by the logic unit;
a fetch engine to retrieve data associated with the instructions from an external memory;
a cache comprising multiple lines, wherein each line holds the data associated with one of the instructions, and wherein each line in the cache comprises a spec-bit; and
a management unit configured to:
set the spec-bit to a speculative state when the data is retrieved for an instruction that has not been committed for execution by the logic unit,
reset the spec-bit from a speculative state to a trusted state when a valid instruction accesses the data associated with the spec-bit, and
prevent the data associated with the spec-bit from remaining in the cache when the spec-bit is in a speculative state and an execution of an instruction that fetched the data is invalid.

2. The processor of claim 1, wherein the management unit is further configured to remove data from the cache when the data is associated with a spec-bit in a speculative state for an invalid instruction.

3. The processor of claim 1, wherein the management unit is further configured to prevent cache probe instructions to interact with data in a cache line associated with a spec-bit in a speculative state.

4. The processor of claim 1, wherein the management unit is further configured to prevent an external source to access data in a cache line associated with a spec-bit in a speculative state, wherein the external source comprises at least one of a read line presence, a cache flush request, and a read from a second processor.

5. The processor of claim 1, wherein the instructions to be executed by the logic unit in the schedule buffer have been checked for dependency prior to be listed in the schedule buffer.

6. The processor of claim 1, further comprising an out-of-order logic which, together with the cache and the schedule buffer, to define a micro-architecture state configured to be modified non-deterministically to improve a processor performance.

7. The processor of claim 1, wherein the schedule buffer is configured to invalidate a speculative instruction that has not been executed prior to a current instruction that is being executed.

8. The processor of claim 1, wherein the data associated with a spec-bit in the speculative state comprises a reserved memory address, and the management unit is configured to prevent access to the reserved memory address when the spec-bit is in the speculative state.

9. The processor of claim 1, wherein the schedule buffer comprises a logic circuit to detect an invalid branch of instructions when a first instruction in a second branch is committed for execution.

10. The processor of claim 1, wherein the schedule buffer clears the spec-bit into a true state when a speculative instruction is retired.

11. A system, comprising:
a memory storing multiple data and multiple instructions; and
a processor configured to execute the instructions using the data, the processor further comprising:
a schedule buffer that lists the instructions to be executed by the processor;
a fetch engine to retrieve data associated with the instructions from an external memory;
a cache comprising multiple lines, wherein each line holds the data associated with one of the instructions, and wherein each line in the cache comprises a spec-bit; and
a management unit configured to:
set the spec-bit to a speculative state when the data is retrieved for an instruction that has not been committed for execution by the processor,
reset the spec-bit from a speculative state to a trusted state when a valid instruction accesses the data associated with the spec-bit, and
prevent the data associated with the spec-bit from remaining in the cache when the spec-bit is in a speculative state and the speculative instruction that fetched the cache line is invalid.

12. The system of claim 11, wherein the management unit is further configured to remove data from the cache when the data is associated with a spec-bit in a speculative state for an invalid instruction.

13. The system of claim 11, wherein the management unit is further configured to prevent cache probe instructions to interact with data in a cache line associated with a spec-bit in a speculative state.

14. The system of claim 11, wherein the management unit is further configured to prevent an external source to access data in a cache line associated with a spec-bit in a speculative state, wherein the external source comprises at least one of a read line presence, a cache flush request, and a read from a second processor.

15. A method, comprising:
retrieving, with a fetch engine, a data associated with an instruction to be executed by a logic unit, from an external memory;
copying the data to a data line in a cache, wherein the data line comprises a spec-bit;
setting, with a management unit, the spec-bit to a speculative state when the instruction has not been committed for execution by the logic unit;
resetting the spec-bit from a speculative state to a trusted state when a valid instruction accesses the data associated with the spec-bit; and
preventing the data associated with the spec-bit from remaining in the cache when the spec-bit is in a speculative state and the instruction is a discarded speculative instruction.

16. The method of claim 15, further comprising removing data from the cache when the data is associated with a spec-bit in a speculative state for an invalid instruction.

17. The method of claim 15, further comprising preventing cache probe instructions to interact with data in a cache line associated with a spec-bit in a speculative state.

18. The method of claim 15, further comprising preventing an external source to access data in a cache line associated with a spec-bit in a speculative state, wherein the external source comprises at least one of a read line presence, a cache flush request, and a read from a second processor.

19. The method of claim 15, further comprising invalidating a speculative instruction that has not been executed prior to a current instruction that is being executed.

20. The method of claim 15, further comprising defining, with an out-of-order logic, a micro-architecture state configured to be modified non-deterministically to improve a processor performance.
